(19) United States
(12) Patent Application Publication
(10) Pub. No.: US 2009/0083790 A1
(43) Pub. Date: Mar. 26, 2009

(54) Video scene segmentation and categorization

(76) Inventors: Tao Wang, Beijing (CN); Yimin Zhang, Beijing (CN)

Correspondence Address: TROP, PRUNER & HU, P.C., 1616 S. VOSS ROAD, SUITE 750, HOUSTON, TX, 77057-2631, US

(21) Appl. No.: 11/904,194

(22) Filed: Sep. 26, 2007

(51) Int. Cl. H04N 5/445

(52) U.S. Cl. 725/38

(57) ABSTRACT

In one embodiment of the invention, an apparatus and method for video browsing, summarization, and/or retrieval, based on video scene segmentation and categorization is disclosed. Video shots may be detected from video data. Key frames may be selected from the shots. A shot similarity graph may be composed based on the key frames. Using normalized cuts on the graph, scenes may be segmented. The segmented scenes may be categorized based on whether the segmented scene is a parallel or serial scene. One or more representative key frames may be selected based on the scene categorization.

### BACKGROUND

As digital video data becomes more and more pervasive, video summarization and retrieval (e.g., video mining) may become increasingly important. Similar to text mining based on parsing of a word, sentence, paragraph, and/or whole document, video mining can be analyzed based on different levels. For example, video data may be analyzed according to the following descending hierarchy: whole video, scene, shot, frame. A scene taken from whole video data may be the basic story unit of the video data or show (e.g., movie, television program, surveillance tape, sports footage) that conveys an idea. A scene may also be thought of as one of the subdivisions of the video in which the setting is fixed, or when it presents continuous action in one place. A shot may be a set of video frames captured by a single camera in one consecutive recording action. Generally, shots of a scene have similar visual content, where the shots may be filmed in a fixed physical setting but with each shot coming from a different camera. In one scene, several transitions from different cameras may be used, which may result in a high visual correlation among the shots. To adequately analyze or mine this video data, scene segmentation may be needed to distinguish one scene from another. In other words, scene segmentation may be used to cluster temporally and spatially coherent or related shots into scenes. Furthermore, categorizing the scenes may be beneficial. In addition, selecting a representative frame from the categorized scenes may further benefit video summarization and retrieval efforts.

### BRIEF DESCRIPTION OF THE DRAWINGS

The accompanying drawings, incorporated in and constituting a part of this specification, illustrate one or more implementations consistent with the principles of the invention and, together with the description of the invention, explain such implementations. The drawings are not necessarily to scale, the emphasis instead being placed upon illustrating the principles of the invention. In the drawings:

FIG. 1 is a flow chart in one embodiment of the invention.

FIG. 2 is a representation of video data in one embodiment of the invention.

### DETAILED DESCRIPTION

The following description refers to the accompanying drawings. Among the various drawings the same reference numbers may be used to identify the same or similar elements. While the following description provides a thorough understanding of the various aspects of the claimed invention by setting forth specific details such as particular structures, architectures, interfaces, and techniques, such details are provided for purposes of explanation and should not be viewed as limiting. Moreover, those of skill in the art will, in light of the present disclosure, appreciate that various aspects of the invention claimed may be practiced in other examples or implementations that depart from these specific details. At certain junctures in the following disclosure descriptions of well known devices, circuits, and methods have been omitted to avoid clouding the description of the present invention with unnecessary detail.

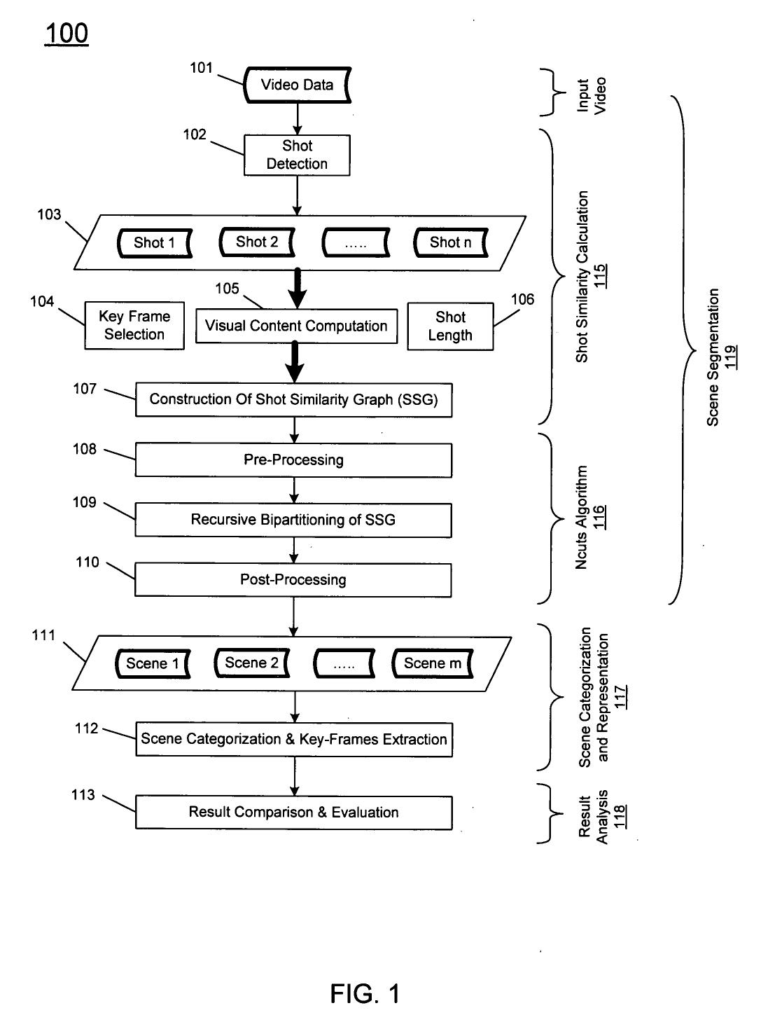

FIG. 1 is a flow chart 100 in one embodiment of the invention. In bock 101, video data is received. Then scene segmentation 119 may begin. Scene segmentation 119 may consist of two main modules: (1) shot similarities calculation 115, and (2) normalized cuts 116 to cluster temporally and spatially coherent shots. In block 102, video shots may be detected. Those shots are listed in block 103. Various video shot detection methods may be used, such as those detailed in J. H. Yuan, W. J. Zheng, L. Chen, Shot Boundary Detection and High-level Feature Extraction, In NIST workshop of TRECVID 2004. In one embodiment of the invention, a 48 bin RGB color histogram with 16 bins for each channel as the visual feature of a frame is used as follows:

$$ColSim ( x , y ) = {\sum }_{h ∈ bins} min ( {H}_{x} ( h ) , {H}_{y} ( h ) )$$

Hₓ is the normalized color histogram of the x^{th} frame. H_{y} is the normalized color histogram of the y^{th} frame. The color similarity between frames x and y is defined as ColSim(x, y) as shown above.

In block 106 regarding shot length, a shot Sᵢ is assumed to include a frame set Sᵢ={f^{a}, f^{a+l}, . . . , f^{b}} where a and b are the start frame and the end frame of the frame set. In block 104, the key frames Kᵢ from the detected shot Sᵢ can be efficiently extracted using various methods such as those detailed in Rasheed, Z. Shah, M, Scene detection in Hollywood movies and TV shows, Computer Vision and Pattern Recognition, 2003, Proceedings. 2003 IEEE Computer Society Conference, vol. 2, pp. 343-8, 18-20 June 2003. For example, the following algorithm may be used. First, select middle frame of the shot Sᵢ as the first key frame as follows: Kᵢ←{f^{[(a+b)/2]}}. Then, for j=a to b:

If max(ColSim(f^{j},f^{k}))<Tₕ∀fεKᵢ

Then Kᵢ←Kᵢ∪{fⁱ}

where Tₕ is the minimum frame similarity threshold and Kᵢ is the key frame set of shot Sᵢ.

In block 105, based on the key frames, the shot similarity ShotSim(i, j) between two shots i and j is calculated as:

ShotSim(i,j)=max_{pεK}_{ᵢ}_{,qεK}_{ⱼ}(ColSim(p,q))

where p and q are key-frames of the shot i and shot j respectively.

In block 107, after shot similarity calculation between two shots, scene segmentation is modeled as a graph partition problem (i.e., graph cut). All shots are represented as a weighted undirected graph G=(V, E), where the nodes V denote the shots and the weight of edges E denote the shot similarity graph (SSG). For scene segmentation, the goal is to seek the optimal partition V₁,V₂,V_{M} of V while satisfying that the similarity among the nodes of each sub-graph Vᵢ is high and across similarity between any two sub-graphs Vᵢ and Vⱼ is low.

To partition the graph, a normalized graph cuts (NCuts) algorithm 116 may be used, such the one described by Jianbo Shi; Malik, J.; Normalized cuts and image segmentation, Pattern Analysis and Machine Intelligence, IEEE Transactions on Volume 22, Issue 8, Page(s):888-905, August 2000. For example, in one embodiment of the invention and for NCuts, the optimal bipartition (V₁, V₂) of a graph V is the one that minimizes the normalized cut value Ncut(V₁, V₂):

$$N cut ( {V}_{1} , {V}_{2} ) = \frac{cut ( {V}_{1} , {V}_{2} )}{assoc ( {V}_{1} , V )} + \frac{cut ( {V}_{1} , {V}_{2} )}{assoc ( {V}_{2} , V )}$$

$$with cut ( {V}_{1} , {V}_{2} ) = {\sum }_{{v}_{1} ∈ {V}_{1} , {v}_{2} ∈ {V}_{2}} w ( {v}_{1} , {v}_{2} )$$

$$assoc ( {V}_{1} , V ) = {\sum }_{{v}_{1} ∈ {V}_{1} , v ∈ V} w ( {v}_{1} , v )$$

where w(v₁,v₂) is the similarity between node v₁ and node v₂. Let x be a [N] dimensional indicator vector, xᵢ=1 if node i is in V₁ or −1 otherwise. NCut satisfies both the minimization of the disassociation between the sub-graphs and the maximization of the association within each sub-graph. The approximate discrete solution to minimize Ncut(V₁, V₂) can be found efficiently by solving the equation as follows:

$${min}_{x} N cut ( x ) = {min}_{y} \frac{{y}^{T} ( D - W ) y}{{y}^{T} D y}$$

$$where$$

$${d}_{i} = {\sum }_{j} w ( i , j ) , D = diag ( {d}_{1} , {d}_{2} , ⋯ , {d}_{n} ) , W ( i , j ) = {w}_{ij} , \\ and$$

$$y = ( 1 + x ) - \frac{{\sum }_{{x}_{i} > 0} {d}_{i}}{{\sum }_{{x}_{i} < 0} {d}_{i}} ( 1 - x ) .$$

partitioning, Graph G could be recursively partitioned (block 109) into M parts by M−1 bipartition operations.

The shot similarity graph W(i, j) may facilitate scene segmentation. Since two shots which are temporally close may belong to a single scene more readily than two distant shots, W(i, j) is proportional not only to the ShotSim(i, j) but also to their temporal/frame distance as follows:

$$W ( i , j ) = exp ( - \frac{1}{d} {\vert \frac{{m}_{i} - {m}_{j}}{σ} \vert}^{2} ) \times ShotSim ( i , j )$$

where mᵢ and mⱼ are the middle frame numbers for shots i and j respectively; σ is the standard deviation of shot durations in the entire video; and d is the temporal decreasing factor. A large value d may result in higher similarity between two shots even if they are temporally far apart. While with a smaller value d, shots may be forgotten quickly, thus forming numerous over-segmented scenes. In Rasheed, Z., Shah, M., Detection and representation of scenes in videos, IEEE Transactions on Multimedia, Vol. 7(6), Page(s):1097-1105, December 2005, d is a “constant” value (e.g., 20), which may be inadequate for videos with different length and types.

However, in one embodiment of the invention, d is related to the shots number N. When the shot number N is large/small, d should correspondently increase/decrease to avoid over-segmentation/under-segmentation. The square of d may be proportional to the shots number N, (e.g., d ∝\sqrt{N}). Therefore, an auto-adaptive value d is used as follows:

$$W ( i , j ) = exp ( - \frac{{( {m}_{i} - {m}_{j} )}^{2}}{{N}^{\frac{1}{2}} {σ}^{2}} ) \times ShotSim ( i , j )$$

In one embodiment of the invention, to enhance the inner correlation of parallel scenes (address below), the shot similarity matrix W or graph is further modified as follows:

if (W(i,i+n)>0.9), d≦5

then W(k,l)=W(i,i+n), i≦k,l≦i+n

The above equation may be useful to avoid a parallel scene being broken into too many segments by NCuts, i.e., over-segmentation of scenes. For example, a dialog scene consists of two kinds of shots/persons A, B, which are alternately displayed in a temporal pattern as A¹→B²→A³→B⁴. Use of the above algorithm may avoid the situation where NCuts segments the dialog scene into four scenes since shots A and B are very different. However, in one embodiment of the invention and according to the situation where W(1,3) are similar and W(2,4) are similar, the above algorithm may set all elements W(k,l) 1≦k,l≦4 to the same value. Therefore, NCuts may not over-segment the dialog scene.

In block 109, the number of partitioning parts M can be decided through at least three approaches. The first one is to manually specify M partitions directly, which is simple but not suitable to variant videos. The second one is to give a maximum threshold of NCut value. Since the NCut value may increase with recursively partitioning of the graph, it will automatically stop the partitioning when the NCut value is bigger than a given threshold. The scene number M generally become larger when increasing the shot number N, but the increasing rate is much smaller than that of N. Therefore, the NCut value threshold T_{cut} may be defined as being proportional to N, (i.e., T_{cut}=α\sqrt{N}+c, where a=0.02 and c=0.3 are good parameters). The third approach may decide the optimal scene number M by an optimum function. In this invention, we use the Q function recently proposed by S. White and P. Smyth, A spectral clustering approach to finding communities in graphs, presented at SIAM International Conference on Data Mining, 2005 to decide the scene number automatically:

$$Q ( {P}_{m} ) = {\sum }_{c = 1}^{m} [ \frac{assoc ( {V}_{c} , {V}_{c} )}{assoc ( V , V )} - {( \frac{assoc ( {V}_{c} , V )}{assoc ( V , V )} )}^{2} ]$$

where Pₘ is a partition of the shots into m sub-groups/scenes by m−1 cuts. The higher value of the Q(Pₘ) function may generally correspond to a better graph partition. Thus, in one embodiment of the invention, the scene number M may be

$$M = {arg max}_{m} Q ( {P}_{m} ) .$$

In block 108, W(i, j) may be pre-processed by the aforementioned approach related to over-segmentation of scenes. In block 110, the partitioned M scenes may be post-processed. For example, if a scene is very short, it may be merged to its neighbor scene with more similar value. If a few conjoined scenes belong to a parallel scene, they may be merged.

In block 111, the video is partitioned into M video segments (i.e., scenes). In block 112 (flow chart area 117), to analyze the content of the scene or scenes, the scene or scenes can be categorized in at least two different ways: (1) parallel scenes and (2) serial scenes. Then, in block 112 as it pertains to key frame extraction and scene representation, extract representative key frames of each scene may be selected for efficient summarization.

Regarding scenes, a scene may be defined as one of the subdivisions of a play in which the setting is fixed, or when it presents continuous action in one place. These definitions, however, may not cover all cases which happen in videos. For example, an outdoor scene may be shot with moving cameras and a variable background. The more appropriate categorization found in the following table may be utilized in one embodiment of the invention.

TABLE 1

| | |
|---|---|
| Parallel scene | 1. Including at least one interacting event (PI) |
| | (e.g., a dialog scene). |
| | 2. Including two or more serial events happening |
| | simultaneously (PS) (e.g., a man is going home on the |
| | road while his child is fighting with thieves at home). |
| Serial scene | Including neither interacting events nor serial events |
| | happening simultaneously (SS). |

An interacting event may be, for example, an even in which two or more characters interact or characters interact with objects of interest (e.g., dialog between two persons) and in a serial event consecutive shots may happen without interactions (e.g., a man drives a car with his girl friend from one city to a mountain).

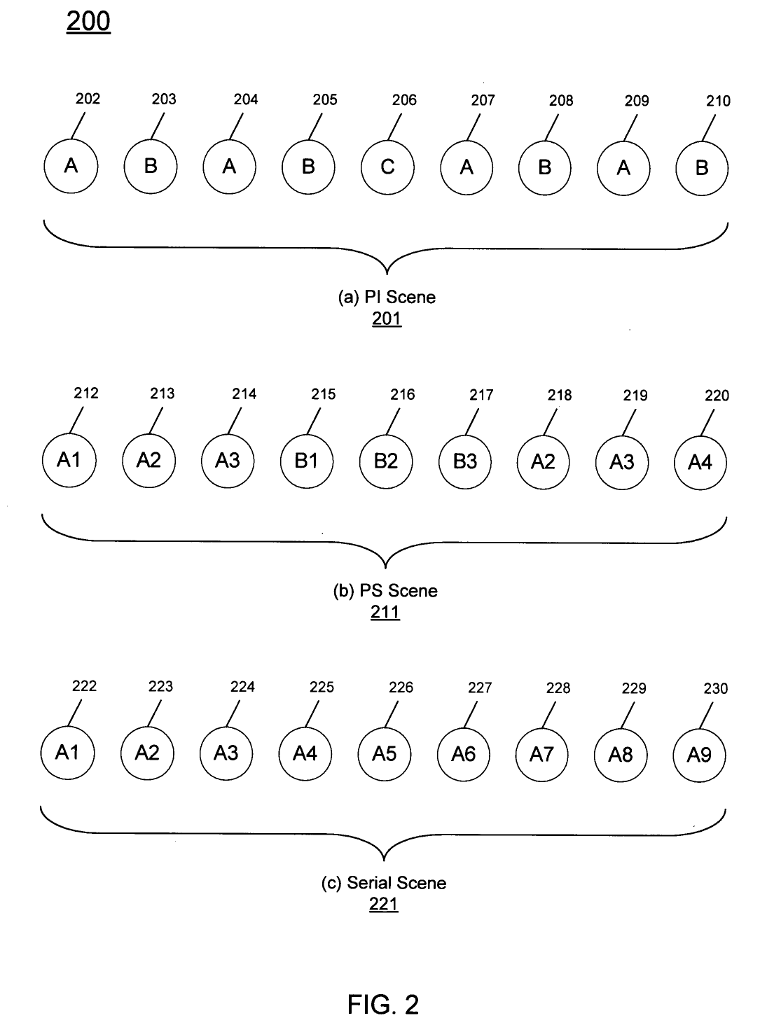

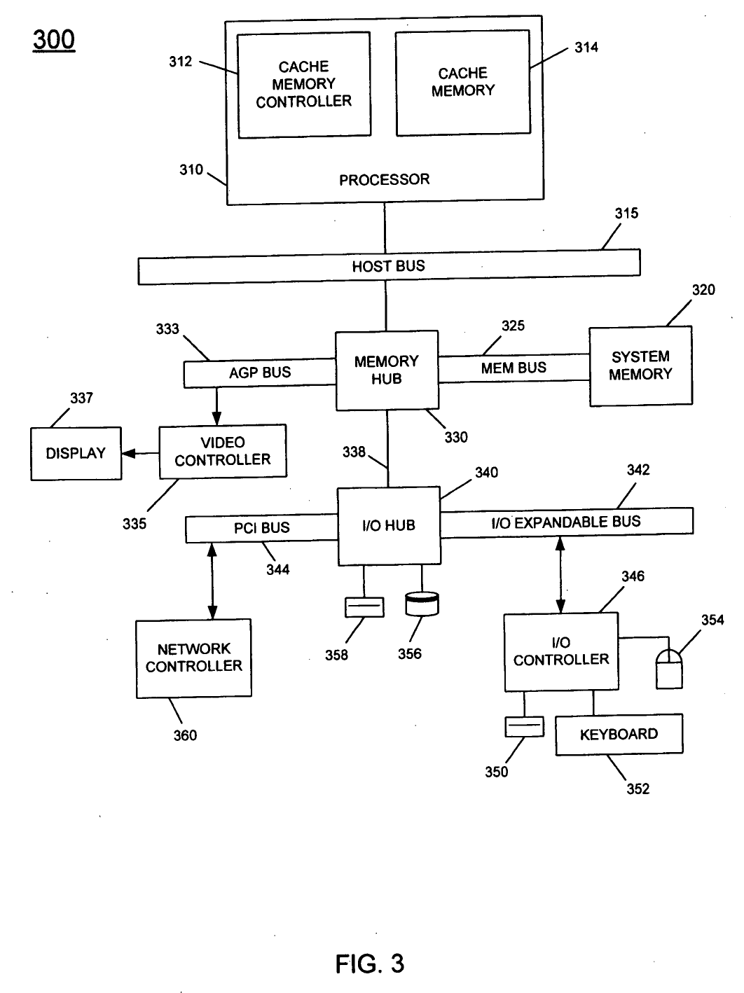

FIG. 2 is a representation of video data 200 in one embodiment of the invention. Each series of video shots 201, 211, 221 show the temporal layout patterns of shots from different scenes. Each circle (e.g., 202) represents one shot, and the same letter in different circles (e.g., 202, 204) illustrates that these shots are similar. For a parallel scene with an interacting event (e.g., PI scene), such as two actors speaking with each other, there may be two fixed cameras capturing the two people. The viewpoints may be switched alternately between the two people 201. For a parallel scene with simultaneous serial events (PS scene) 211, video may switch between two serial events. For serial scene (SS) 221, such as a man traveling from one place to another site, the camera setting may keep changing and shots may also change.

Again referring to block 112, the shot similarity matrix or graph W(i, j) may be used to categorize scenes into different types. As shown above, ShotSim(i, j) may be acquired, which is in the range of [0, 1]. If ShotSim(i, j)>Sₗ (experimentally Sₗ=0.8), shots i and j may be captured consecutively from a fixed camera view. The shots i and j may thus be similar and be labeled with the same letter but different sequential number, such as A1, A2 (e.g., 222, 223, . . . ). If ShotSim(i, j)>Sₕ (experimentally Sₕ=0.9), there may be almost no change between shot i and shot j, so they may be deemed as the same shot and labeled with the same letter such as 202, 204. A scene categorization algorithm in one embodiment of the invention may be described as follows.

```
Categorize a scene which consists of shotₐ, shotₐ₊₁, ..., shot_{b}
/* Label shots by their temporal layout */
Label shot a with letter A
FOR shot i = a to b − 1
  FOR shot j = i + 1 to b
    IF ShotSim(i,j)> Sₕ, Label shot j the same letter with shot i.
    ELSE IF ShotSim(i,j)< Sₗ, Label shot j with a new sequential
    character e.g. B, C, D...
  END
END
WHILE not all shots are labeled
  IF Sₗ <ShotSim(i,j) < Sₕ , Label shot j with the same letter and
  different sequential number of shot i.
END
//* Scene Categorization: */
```

1. Two letters switching regularly: Parallel scene;
2. Two letter groups switching regularly (Group length not exceed L=5): Parallel scene:
3. Shots with same letter and consecutive number: Serial scene
4. Other situations: Serial scene

The Serial Scene and PS scene may be variable. If the serial events in PS scene are very long, they may be segmented as individual serial scenes. Such a situation may exist in films or TV shows. Thus, by scene categorization one may acquire useful cues for content analysis and semantic event detection. For example, the PI scene with constant faces generally corresponds to human dialogue. The key frames may be selected with frequently appearing characters for scene representation.

Again in block 112 as it pertains to key frame extraction and scene representation, scene representation may concern selecting one or more key-frames from representative shots to represent a scene's content. Based on shot similarity described above, a representative shot may have high similarity with other shots and may span a long period of time. Therefore, the shot goodness G(i) may be defined as:

$$G ( i ) = {C ( i )}^{2} * Length ( i )$$

$$with$$

$$C ( i ) = {\sum }_{j ∈ Scene} ShotSim ( i , j )$$

The more similar shot i is with other shots j in the scene, the larger C(i) and G(i) are. Furthermore, G(i) may also be proportional to the duration of shot i. For a PI scene, one can select key frames from both good shot A and good shot B (see FIG. 2). For the PS scene, key-frames could be extracted from its sub serial-event group shots.

Thus, a novel NCuts based scene segmentation and categorization approach may be employed in one embodiment of the invention. Starting from a set of shots, shot similarity may be calculated from shot key frames. Then, by modeling scene segmentation as a graph partition problem, NCuts may be employed to find the optimal scene segmentation. To discover more useful information from scenes, temporal layout patterns of shots may be analyzed and scenes may be automatically categorized into two different types (e.g., parallel scene and serial scene). The scene categorization may be useful for content analysis and semantic event detection (e.g., a dialog can be detected from the parallel scenes with interacting events and constant faces). Also, according to scene categories, one or multiple key-frames may be automatically selected to represent a scene's content. The scene representation may be valuable for video browsing, video summarization and video retrieval. For example, embodiments of the invention may be useful for video applications such as video surveillance, video summarization, video retrieval, and video editing but are not limited to these applications.

Embodiments may be used in various systems. As used herein, the term “computer system” may refer to any type of processor-based system, such as a notebook computer, a server computer, a laptop computer, or the like. Now referring to FIG. 3, in one embodiment, computer system 300 includes a processor 310, which may include a general-purpose or special-purpose processor such as a microprocessor, microcontroller, a programmable gate array (PGA), and the like. Processor 310 may include a cache memory controller 312 and a cache memory 314. While shown as a signal core, embodiments may include multiple cores and may further be a multiprocessor system including multiple processors 310. Processor 310 may be coupled over a host bus 315 to a memory hub 330 in one embodiment, which may be coupled to a system memory 320 (e.g., a dynamic RAM) via a memory bus 325. Memory hub 330 may also be coupled over an Advanced Graphics Port (AGP) bus 333 to a video controller 335, which may be coupled to a display 337.

Memory hub 330 may also be coupled (via a hub link 338) to an input/output (I/O) hub 340 that is coupled to an input/output (I/O) expansion bus 342 and a Peripheral Component Interconnect (PCI) bus 344, as defined by the PCI Local Bus Specification, Production Version, Revision 2.1 dated June 1995. I/O expansion bus 342 may be coupled to an I/O controller 346 that controls access to one or more I/O devices. These devices may include in one embodiment storage devices, such as a floppy disk drive 350 and input devices, such as a keyboard 352 and a mouse 354. I/O hub 340 may also be coupled to, for example, a hard disk drive 358 and a compact disc (CD) drive 356. It is to be understood that other storage media may also be included in the system.

PCI bus 344 may also be coupled to various components including, for example, a network controller 360 that is coupled to a network port (not shown). A communication device (not shown) may also be coupled to the bus 344. Depending upon the particular implementation, the communication device may include a transceiver, a wireless modem, a network interface card, LAN (Local Area Network) on motherboard, or other interface device. The uses of a communication device may include reception of signals from wireless devices. For radio communications, the communication device may include one or more antennas. Additional devices may be coupled to the I/O expansion bus 342 and the PCI bus 344. Although the description makes reference to specific components of system 300, it is contemplated that numerous modifications and variations of the described and illustrated embodiments may be possible.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below. It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, while the present invention has been described with respect to a limited number of embodiments, those skilled in the art will appreciate numerous modifications and variations therefrom.

What is claimed is:

1. A method comprising:
receiving a first digital video that includes a first scene comprising a first plurality of video shots, the first plurality of video shots including n video shots;
distinguishing a first video shot of the n video shots from a second video shot of the n video shots;
identifying a first key frame for the first video shot and a second key frame for the second video shot;
determining whether the first scene includes both the first shot and the second shot based on the value of n.

2. The method of claim 1, further comprising determining whether the first scene includes both the first shot and the second shot based on whether the first scene includes a first serial event.

3. The method of claim 2, further comprising determining whether the first scene includes both the first shot and the second shot based on whether the first scene includes a second serial event that occurs simultaneously with the first serial event.

4. The method of claim 1, further comprising determining whether the first scene includes both the first shot and the second shot based on whether the first scene includes an interacting event.

5. The method of claim 1, further comprising:
determining the first scene includes the first shot and the second shot; and
selecting the first key frame as a first representative frame based on whether the first scene includes a first serial event.

6. The method of claim 5, further comprising selecting the second key frame as a second representative frame based on whether the first scene includes a first serial event.

7. The method of claim 1, further comprising categorizing the first scene based on whether the first scene includes a first serial event.

8. The method of claim 7, further comprising categorizing the first scene based on whether the first scene includes a second serial event that occurs simultaneously with the first serial event.

9. The method of claim 1, further comprising categorizing the first scene based on whether the first scene includes an interacting event.

10. An apparatus comprising:
a memory to receive a first digital video that includes a first scene comprising a first plurality of video shots, the first plurality of video shots including n video shots;
a processor, coupled to the memory, to:
distinguish a first video shot of the n video shots from a second video shot of the n video shots;
determine whether the first scene includes both the first shot and the second shot based on the value of n.

11. The apparatus of claim 10, wherein the processor is to determine whether the first scene includes both the first shot and the second shot based on whether the first scene includes a first serial event.

12. The apparatus of claim 10, wherein the processor is to determine whether the first scene includes both the first shot and the second shot based on whether the first scene includes an interacting event.

13. The apparatus of claim 10, wherein the processor is to:
determine the first scene includes the first shot and the second shot;
identify a first key frame for the first video shot and a second key frame for the second video shot; and
select the first key frame as a first representative frame based on whether the first scene includes a first serial event.

14. The apparatus of claim 13, wherein the processor is to select the second key frame as a second representative frame based on whether the first scene includes a first serial event.

15. The apparatus of claim 10, wherein the processor is to categorize the first scene based on whether the first scene includes a first serial event.
